(19) United States
(12) Patent Application Publication
(10) Pub. No.: US 2011/0066441 A1
(43) Pub. Date: Mar. 17, 2011

(54) METHOD FOR PREDICTING REACTIVITY OF A HYDROCARBON-CONTAINING FEEDSTOCK FOR HYDROPROCESSING

(75) Inventors: Cesar Ovalles, Walnut Creek, CA (US); Estrella Rogel, Orinda, CA (US); Michael Moir, San Rafael, CA (US)

(73) Assignee: Chevron U.S.A. Inc.

(21) Appl. No.: 12/833,802

(22) Filed: Jul. 9, 2010

Related U.S. Application Data
(60) Provisional application No. 61/242,280, filed on Sep. 14, 2009.
(60) Provisional application No. 61/312,765, filed on Mar. 11, 2010.

(51) Int. Cl. G06F 19/00; G06Q 99/00; G06Q 90/00; G01N 31/00

(52) U.S. Cl. 705/1.1; 705/500; 702/25

(57) ABSTRACT

Disclosed herein is a method involving the steps of (a) precipitating an amount of asphaltenes from a liquid sample of a first hydrocarbon-containing feedstock having solvated asphaltenes therein with one or more first solvents in a column; (b) determining one or more solubility characteristics of the precipitated asphaltenes; (c) analyzing the one or more solubility characteristics of the precipitated asphaltenes; and (d) correlating a measurement of feedstock reactivity for the first hydrocarbon-containing feedstock sample with a mathematical parameter derived from the results of analyzing the one or more solubility characteristics of the precipitated asphaltenes.

### BACKGROUND OF THE INVENTION

1. Technical Field

The present invention generally relates to a method for predicting reactivity of a hydrocarbon-containing feedstock for hydroprocessing.

2. Description of the Related Art

Presently, the petroleum industry relies more heavily on relatively high boiling feedstocks derived from materials such as coal, tar sands, oil-shale, and heavy crudes. These feedstocks generally contain significantly more undesirable components, especially from an environmental point of view. For example, such undesirable components include halides, metals and heteroatoms such as sulfur, nitrogen, and oxygen. Furthermore, specifications for fuels, lubricants, and chemical products, with respect to such undesirable components, are continually becoming stricter. Consequently, such feedstocks and product streams require more severe upgrading in order to reduce the content of such undesirable components. More severe upgrading, of course, adds considerably to the expense of processing these petroleum streams.

Hydroprocessing, which includes by way of example hydroconversion, hydrocracking, hydrotreating, hydrogenation, hydrofinishing and hydroisomerization, plays an important role in upgrading petroleum feedstocks to meet the more stringent quality requirements. For example, there is an increasing demand for improved hetero-atom removal, aromatic saturation, and boiling point reduction as well as removal of metal contaminants such as Vanadium and Nickel. Much work is presently being done in hydrotreating because of greater demands for the removal of undesirable components such as heteroatoms, most notably sulfur, from transportation and heating fuel streams. Hydrotreating is well known in the art and usually involves treating the petroleum streams with hydrogen in the presence of a supported catalyst at hydrotreating conditions.

Hydrocarbon feedstocks likewise generally contain polar core materials, such as asphaltenes, dispersed in lower polarity solvent(s). Intermediate polarity material(s), usually referred to as resin(s), can associate with the polar core materials to maintain a homogeneous mixture of the components.

Asphaltenes are organic heterocyclic macromolecules which occur in crude oils. Under normal reservoir conditions, asphaltenes are usually stabilized in the crude oil by maltenes and resins that are chemically compatible with asphaltenes, but that have lower molecular weight. Polar regions of the maltenes and resins surround the asphaltene while non-polar regions are attracted to the oil phase. However, changes in pressure, temperature or concentration of the crude oil can alter the stability of the dispersion and increase the tendency of the asphaltenes to agglomerate into larger particles. As these asphaltene agglomerates grow, so does their tendency to precipitate out of solution.

One of the problems encountered in crude oil production and refining is asphaltene precipitation. Generally, unwanted asphaltene precipitation is a concern to the petroleum industry due to, for example, plugging of an oil well or pipeline as well as stopping or decreasing oil production. Also, in downstream applications, asphaltenes are believed to be the source of coke during thermal upgrading processes thereby reducing and limiting yield of residue conversion. In catalytic upgrading processes, asphaltenes can contribute to catalyst poisoning by coke and metal deposition thereby limiting the activity of the catalyst.

Asphaltenes can also cause fouling in, for example, heat exchangers and other equipments in a refinery. Fouling in heat transfer equipments used for streams of petroleum origin can result from a number of mechanisms including chemical reactions, corrosion and the deposit of materials made insoluble by the temperature difference between the fluid and heat exchange wall. The presence of insoluble contaminants may exacerbate the problem: blends of a low-sulfur, low asphaltene (LSLA) crude oil and a high-sulfur, high asphaltene (HSHA) crude, for example, may be subject to a significant increase in fouling in the presence of iron oxide (rust) particulates. Subsequent exposure of the precipitated asphaltenes over time to the high temperatures then causes formation of coke as a result of thermal degradation.

Accordingly, it would be advantageous to characterize a hydrocarbon-containing feedstock prior to subjecting it to hydroprocessing in order to determine how a particular feedstock will react during hydroprocessing. Thus, it would be desirable to provide methods for predicting reactivity of a hydrocarbon-containing feedstock for hydroprocessing that can be carried out in a simple, cost efficient and repeatable manner.

### SUMMARY OF THE INVENTION

In accordance with one embodiment of the present invention, there is provided a method comprising the steps of:

(a) precipitating an amount of asphaltenes from a liquid sample of a first hydrocarbon-containing feedstock having solvated asphaltenes therein with one or more first solvents in a column;

(b) determining one or more solubility characteristics of the precipitated asphaltenes;

(c) analyzing the one or more solubility characteristics of the precipitated asphaltenes; and

(d) correlating a measurement of feedstock reactivity for the first hydrocarbon-containing feedstock sample with a mathematical parameter derived from the results of analyzing the one or more solubility characteristics of the precipitated asphaltenes.

In accordance with a second embodiment of the present invention, there is provided a method comprising the steps of:

(a) precipitating an amount of asphaltenes from a liquid sample of a first hydrocarbon-containing feedstock having solvated asphaltenes therein with one or more first solvents in a column;

(b) determining one or more solubility characteristics of the precipitated asphaltenes;

(c) analyzing the one or more solubility characteristics of the precipitated asphaltenes;

(d) correlating a measurement of feedstock reactivity for the first hydrocarbon-containing feedstock sample with a mathematical parameter derived from the results of analyzing the one or more solubility characteristics of the precipitated asphaltenes; and

(e) selecting a second hydrocarbon-containing feedstock sample; repeating steps (a)-(d); and comparing the results of the second hydrocarbon-containing feedstock sample with the results of the first hydrocarbon-containing feedstock sample to predict a leading candidate hydrocarbon-containing feedstock for reactivity for hydroprocessing.

In accordance with a third embodiment of the present invention, there is provided a method comprising the steps of:

(a) precipitating an amount of asphaltenes from a liquid sample of a first hydrocarbon-containing feedstock having solvated asphaltenes therein with one or more first solvents in a column;

(b) determining one or more solubility characteristics of the precipitated asphaltenes;

(c) analyzing the one or more solubility characteristics of the precipitated asphaltenes;

(d) correlating a measurement of feedstock reactivity for the first hydrocarbon-containing feedstock sample with a mathematical parameter derived from the results of analyzing the one or more solubility characteristics of the precipitated asphaltenes; and

(e) selecting a different sample of the same first hydrocarbon-containing feedstock sample and comparing the different sample with the results of the first hydrocarbon-containing feedstock sample.

In accordance with a fourth embodiment of the present invention, there is provided a method comprising the steps of:

(a) selecting one or more hydrocarbon-containing feedstocks, wherein the selection of the one or more hydrocarbon-containing feedstocks comprises:
(i) precipitating an amount of asphaltenes from a liquid sample of a first hydrocarbon-containing feedstock having solvated asphaltenes therein with one or more first solvents in a column;
(ii) determining one or more solubility characteristics of the precipitated asphaltenes;
(iii) analyzing the one or more solubility characteristics of the precipitated asphaltenes; and
(iv) correlating a measurement of feedstock reactivity for the first hydrocarbon-containing feedstock sample with a mathematical parameter derived from the results of analyzing the one or more solubility characteristics of the precipitated asphaltenes; and

(b) feeding the selected one or more hydrocarbon-containing feedstocks to one or more crude hydrocarbon refinery components.

In accordance with a fifth embodiment of the present invention, there is provided a system comprising: (a) one or more crude oil hydrocarbon components; and (b) one or more hydrocarbon-containing feedstocks in fluid communication with the one or more crude hydrocarbon refinery components, wherein the one or more hydrocarbon-containing feedstocks are selected by a process comprising:

(i) precipitating an amount of asphaltenes from a liquid sample of a first hydrocarbon-containing feedstock having solvated asphaltenes therein with one or more first solvents in a column;

(ii) determining one or more solubility characteristics of the precipitated asphaltenes;

(iii) analyzing the one or more solubility characteristics of the precipitated asphaltenes; and

(iv) correlating a measurement of feedstock reactivity for the first hydrocarbon-containing feedstock sample with a mathematical parameter derived from the results of analyzing the one or more solubility characteristics of the precipitated asphaltenes.

In accordance with a sixth embodiment of the present invention, there is provided a method of transforming a product development process to reduce time in bringing a product to market, the method comprising the steps of:

(a) precipitating an amount of asphaltenes from a liquid sample of a first hydrocarbon-containing feedstock having solvated asphaltenes therein with one or more first solvents in a column;

(b) determining one or more solubility characteristics of the precipitated asphaltenes;

(c) analyzing the one or more solubility characteristics of the precipitated asphaltenes;

(d) correlating a measurement of feedstock reactivity of asphaltenes for the first hydrocarbon-containing feedstock sample with a mathematical parameter derived from the results of analyzing the one or more solubility characteristics of the precipitated asphaltenes; and

(e) generating a price of the first hydrocarbon-containing feedstock.

The methods of the present invention advantageously predicts a leading candidate hydrocarbon-containing feedstock for the reactivity for hydroprocessing in a simple, cost efficient and repeatable manner. In this way, the leading candidate hydrocarbon-containing feedstock can be readily characterized to assist in optimizing process conditions and/or catalyst to oil ratios in order to maximize residue conversions and/or product yields from one or more hydroprocessing techniques. Furthermore, by utilizing the key properties associated with the reactivity/processability of a given feedstock, quality control of new batches of feedstocks and in blending raw materials can be achieved without affecting process and/or catalyst operation conditions.

### BRIEF DESCRIPTION OF THE DRAWINGS

FIG. 1 is a graph of the asphaltene solubility fractions for three reference feedstocks showing the response versus time using an Evaporative Light Scanning Detector.

FIG. 2 is a graph of the asphaltene solubility fractions for three reference feedstocks showing the response versus time using a Diode Array Detector.

FIG. 3 is a graph showing feed reactivity (measured as HDN rate constant in h⁻¹) versus the percentages of areas of asphaltenes.

FIG. 4 is a graph showing feed reactivity (measured as HDN rate constant in h⁻¹) versus the ratio of the area of “easy-to-react” to that of the “hard-to-process” asphaltenes.

FIG. 5 is a graph showing feed reactivity (measured as HDN rate constant in h⁻¹) versus Feed Reactivity 1 as calculated by equation 1.

FIG. 6 is a graph showing feed reactivity (measured as % reduction of MCR) versus the percentages of areas of asphaltenes

FIG. 7 is a graph showing feed reactivity (measured as % reduction of MCR) versus ratio of the areas “easy-to-react” to “hard-to-process” asphaltenes.

FIG. 8 is a graph showing asphaltene solubility profiles for both Samples #1 (Canadian VR) and #2 (Middle East VR) as response versus time for the asphaltenes.

FIG. 9 is a graph showing feed reactivity (measured as HDN rate constant in h⁻¹) versus APS.

FIG. 10 is a graph showing feed reactivity (measured as HDN rate constant in h⁻¹) versus overlapping area (between the hard-to-dissolve asphaltene and easy to dissolve asphaltenes)/hard-to-dissolved asphaltene ratio.

FIG. 11 is a graph showing feed reactivity (measured as HDN rate constant in h⁻¹) versus Feed Reactivity 1 as calculated by equation 1.

FIG. 12 is a graph showing feed reactivity (measured as % of reduction of MCR) versus overlapping/hard-to-dissolved asphaltene ratio.

FIG. 13 is a graph showing feed reactivity (measured as percentage of reduction of MCR) versus Feed Reactivity 2 as calculated by equation 2.

### DETAILED DESCRIPTION OF THE PREFERRED EMBODIMENTS

In one embodiment, a method of the present invention involves (a) precipitating an amount of asphaltenes from a liquid sample of a first hydrocarbon-containing feedstock having solvated asphaltenes therein with one or more first solvents in a column; (b) determining one or more solubility characteristics of the precipitated asphaltenes; (c) analyzing the one or more solubility characteristics of the precipitated asphaltenes; and (d) correlating a measurement of feedstock reactivity for the first hydrocarbon-containing feedstock sample with a mathematical parameter derived from the results of analyzing the one or more solubility characteristics of the precipitated asphaltenes.

Generally, the source of the hydrocarbon-containing feedstock may be any source wherefrom a hydrocarbon crude may be obtained, produced, or the like. The source may be one or more producing wells in fluid communication with a subterranean oil reservoir. The producing well(s) may be under thermal recovery conditions, or the producing well(s) may be in a heavy oil field where the hydrocarbon crude or oil is being produced from a reservoir having a strong water-drive.

In one embodiment, the hydrocarbon-containing feedstock sample includes any heavy hydrocarbons such as heavy crude oil, heavy hydrocarbons extracted from tar sands, commonly called tar sand bitumen, such as Athabasca tar sand bitumen obtained from Canada, heavy petroleum crude oils such as Venezuelan Orinoco heavy oil belt crudes, Boscan heavy oil, Hamaca crude oil, heavy hydrocarbon fractions obtained from crude petroleum oils, particularly heavy vacuum gas oils, vacuum residuum as well as petroleum tar, tar sands and coal tar. Other examples of heavy hydrocarbon feedstocks which can be used are oil shale, shale, coal liquefaction products and the like.

In another embodiment, the hydrocarbon-containing feedstock sample includes any solid hydrocarbon-containing deposit such as asphaltene solids from, e.g., refinery production preparation or an oil facility.

In another embodiment, the hydrocarbon-containing feedstock sample includes any processed sample such as heavy cycle gas oil (HCGO), LC Fining products, fluid catalytic cracking (FCC) products and the like.

In one embodiment, a liquid sample of a hydrocarbon-containing feedstock having solvated asphaltenes therein is provided. As one skilled in the art will readily understand, it may be necessary to add a solvent to the hydrocarbon-containing feedstock in order for the sample to be sufficiently fluid enough to be passed through the column. Useful solvents include any solvent in which the hydrocarbon-containing feedstock sample is soluble or which is capable of allowing the hydrocarbon-containing feedstock sample to be sufficiently fluid to be passed through the column. Representative examples of such solvents include one or more chlorinated hydrocarbon solvents, one or more aromatic hydrocarbon solvents, one or more ether solvents, one or more alcohol solvents and the like and mixtures thereof. Suitable chlorinated hydrocarbon solvents include, but are not limited to, dichloromethane, 1,2-dichloroethane, chloroform, carbon tetrachloride and the like and mixtures thereof. Suitable aromatic hydrocarbon solvents include, but are not limited to, benzene, toluene, xylene and the like and mixtures thereof. Suitable ether solvents include tetrahydrofuran, diethylether, dioxane and the like and mixtures of thereof. Suitable alcohol solvents include low molecular weight aliphatic alcohols such as methanol, ethanol, isopropanol and the like and mixtures thereof.

In one embodiment, the sample solution can be prepared from about 10 to about 50 wt. % solution of the hydrocarbon-containing feedstock sample in the solvent(s).

Initially, at least a portion of the sample solution is injected into a column. Generally, the column will have an inlet and an outlet and can be any type of column which is hollow and permits the flow of an aqueous-type material through the interior of the column. The column can be any size and cross sectional shape, e.g., the column can be cylindrical, square, rectangular, triangular, or any other geometrical shape as long as it is hollow and permits the passing of aqueous-type material. In one embodiment, the column is cylindrical. Furthermore, the column can be of any suitable length and any inner diameter or inner cross-sectional area. In one embodiment, the column can have a diameter of from about 0.25 inches to about 1 inch and a length of from about 50 mm to about 500 mm. One skilled the art could envisage that the column can generally be any inert filtration device for use the methods of the present invention.

Any suitable material may be selected for use as the column. For example, the column can be formed of a relatively inert or chemically unreactive material such as glass, stainless steel, polyethylene, polytetrafluoroethylene (PTFE), polyaryletheretherketone, (PEEK), silicon carbide or mixtures of thereof, for example, a PEEK-lined stainless steel column.

The column may be vertical or horizontal or arranged in any suitable way, provided that it can be loaded with the sample solution and that the appropriate solvent(s) can be passed through it. As will be understood by those of ordinary skill in the art, a pump may also be used to increase the flow rate through the column.

In another embodiment, an inert packing material is included within the column. The amount of the inert packing material should not exceed an amount which will prevent the passing of any liquid containing material through the column. The packed column advantageously allows for the use of a relatively small volume of sample solution and solvent(s). Suitable inert packing material includes any material that is inert to asphaltene irreversible adsorption. Examples of such materials include fluorinated polymers such as, for example, polyvinylidene fluoride (PVDF), fluorinated ethylene propylene (FEP), polytetrafluoroethylene (PTFE), silicon carbide, polydivinylbenzene (PDVB) and the like and mixtures thereof.

Once the sample solution has been passed into the column, one or more first solvents are then passed through the column. Useful one or more first solvents are typically alkane mobile phase solvent(s) and can be determined by one skilled in the art. In one embodiment, the alkane mobile phase solvent is n-heptane. However, other alkane mobile phase solvents such as, for example, n-pentane or n-hexane may be used.

The one or more first solvents should be passed into the column for a time period sufficient to elute the alkane soluble fraction, commonly known as maltenes or petrolenes, and induce precipitation of the alkane insoluble fraction, i.e., the precipitated asphaltenes, from the hydrocarbon-containing feedstock sample. Generally, once the alkane mobile phase solvent (i.e., one or more first solvents) enters the column, the alkane mobile phase solvent dilutes and displaces the solvent in the sample solution, thereby allowing the asphaltenes to substantially precipitate therefrom. The alkane soluble fraction then elutes from the column.

Step (b) of the method of the present invention involves determining one or more solubility characteristics of the precipitated asphaltenes once substantially all of the alkane soluble fraction has eluted. The one or more solubility characteristics of the precipitated asphaltenes to be determined include, by way of example, solubility parameters, miscibility numbers, kauri-butanol numbers, dipole moments, relative permitivities, polarity indexes, refractive indexes and specific types of intermolecular interaction in liquid media such as acid and base numbers. Various ways to determine the one or more solubility characteristics of the precipitated asphaltenes are within the purview of one skilled in the art. For example, in one embodiment, the step of determining one or more solubility characteristics of the precipitated asphaltenes involves (1) dissolving at least part of the amount of the precipitated asphaltenes in one or more second solvents having a solubility parameter at least 0.7 MPa^{0.5} higher than the one or more first solvents; and (2) dissolving a second amount of the precipitated asphaltenes in one or more third solvents having a solubility parameter higher than the one or more second solvents, wherein the solubility parameter of the one or more third solvents is at least about 21 MPa^{0.5} but no greater than about 30 MPa^{0.5}. A solubility parameter as described herein is determined by the Hansen's methodology described in Barton, A. F. M. Handbook of Solubility Parameters and Other Cohesion Parameters; CRC Pres Inc.: Boca Raton, Fla., p. 95 (1983).

Suitable one or more second solvents having a solubility parameter at least 0.7 MPa^{0.5} higher than the one or more first solvents can be determined by one skilled in the art. Useful solvents include, but are not limited to, one or more alkane solvents, one or more chlorinated hydrocarbon solvents, one or more aromatic solvents, one or more ether solvents, one or more alcohol solvents and the like and mixtures thereof. Representative examples of such solvents can be any of those disclosed above. It is also contemplated that blends of such solvents can be used. In one embodiment, a blend can contain from about 0.5 wt. % to about 99.5 wt. % chlorinated solvent and from about 99.5 wt. % to about 0.5 wt. % alkane solvent. In another embodiment, a blend can contain from about 10 wt. % to about 25 wt. % chlorinated solvent and from about 90 wt. % to about 75 wt. % alkane solvent.

Suitable one or more third solvents having a solubility parameter higher than the one or more second solvents, wherein the solubility parameter of the one or more third solvents is at least about 21 MPa^{0.5} but no greater than about 30 MPa^{0.5}, can be determined by one skilled in the art. Generally, the one or more third solvents will dissolve any remaining precipitated asphaltenes in the column. Useful solvents include, but are not limited to, one or more alcohol solvents, one or more chlorinated hydrocarbon solvents, one or more aromatic solvents, one or more ether second solvents and the like and mixtures thereof. Representative examples of such solvents can be any of those disclosed above. It is also contemplated that blends of such solvents can be used. In one embodiment, a blend can contain from about 0.5 wt. % to about 99.5 wt. % chlorinated solvent and from about 99.5 wt. % to about 0.5 wt. % alcohol solvent. In another embodiment, a blend can contain from about 80 wt. % to about 95 wt. % chlorinated solvent and from about 20 wt. % to about 5 wt. % alcohol solvent.

If desired, one or more additional solvents or solvent blends can be added to dissolve at least part of the amount of the precipitated asphaltenes after the addition of the one or more second solvents and before the addition of the one or more third solvents. In general, the one or more additional solvents or solvent blends will have a solubility parameter greater than the previously added one or more solvents or solvent blends and less than the solubility parameter of the one or more third solvents. For example, one or more fourth solvents having a solubility parameter between the solubility parameter of the one or more second solvents and the solubility parameter of the one or more third solvents can be added to dissolve at least part of the amount of the precipitated asphaltenes. In another embodiment, one or more fifth solvents having a solubility parameter between the solubility parameter of the one or more fourth solvents and the solubility parameter of the one or more third solvents can be added to dissolve at least part of the amount of the precipitated asphaltenes. In yet another embodiment, one or more sixth solvents having a solubility parameter between the solubility parameter of the one or more fifth solvents and the solubility parameter of the one or more third solvents can be added to the dissolve at least part of the amount of the precipitated asphaltenes.

Suitable additional solvents include, but are not limited to, one or more alkane solvents, one or more chlorinated hydrocarbon solvents, one or more alcohol solvents, one or more aromatic solvents and the like and mixtures thereof. Representative examples of such solvents can be any of those disclosed above.

The asphaltene concentration in the eluted fractions from the column is continuously monitored using, for example, a liquid chromatography detector which generates a signal proportional to the amount of each eluted fraction and is recorded in a manner well known in the art. There are a number of commercially available liquid chromatography detectors that can be used including, e.g., refractive index detectors, mass spectrometry, liquid chromatography/mass spectrometry, NMR spectroscopy, Raman spectroscopy, infrared spectroscopy, fluorescence spectroscopy, UV-Vis spectroscopy, diode array detector, Charged Aerosol, evaporative light scattering detectors (ELSD) and the like; all of which can be used in the methods described herein. Other online detectors are known to those skilled in the art. Quantification can then be performed using methods known in the art, e.g., using commercially-available computer programs.

In one preferred embodiment, an evaporative light scattering detector is used as a liquid chromatography detector to monitor each eluting sample's concentration to determine the solubility characteristics of the precipitated asphaltenes. The operating principle of an evaporative light scattering detector is as follows: the compounds to be analyzed are transported by a mobile phase or a more volatile carrier liquid which is then nebulized and evaporated at a relatively low temperature (being able to be in the order of from about 30 to about 150° C.) so that residual micro-particles alone remain—ideally the compounds to be analyzed—which can be detected by light scattering. In this manner, it is possible to analyze directly effluents which originate from the column under the condition of selecting a mobile phase which is volatile enough to be directly used as a carrier liquid for the evaporative light scattering detector. For example, in the case of the asphaltenes, the result is a single peak for each eluted solvent fraction which represents the solubility characteristics of the asphaltenes.

Once the one or more solubility characteristics have been analyzed for a given hydrocarbon-containing feedstock sample, a mathematical parameter derived from the one or more solubility characteristics is correlated with one or more measurements of feedstock reactivity of the hydrocarbon-containing feedstock. For example, a mathematical parameter can be derived by calculating a percentage of each peak area for the first amount or the second amount of dissolved asphaltenes relative to the total peak areas, wherein the peak areas are derived from the signals generated from the detector. Other mathematical parameters derived from the one or more solubility characteristics are within the purview of one skilled in the art and illustrated in the examples herein. Various ways to correlate the one or more measurements of feedstock reactivity of the hydrocarbon-containing feedstock with the one or more mathematical parameters are also within the purview of one skilled in the art and illustrated in the examples. However, other ways to correlate the one or more measurements of feedstock reactivity of the hydrocarbon-containing feedstock with the one or more mathematical parameters can readily be determined by one skilled in the art.

The one or more measurements of feedstock reactivity for the hydrocarbon-containing feedstock samples can be any known measurements of feedstock reactivity, such as those disclosed in, for example, Murray, M. R. “Upgrading Petroleum Residues and Heavy Oil”, Dekker, New York, (1994) and Gray, M. R., Energy & Fuels, 17, p. 1566 (2003) For example, a measurement of feedstock reactivity comprises one or more measurements in terms of hydrodenitrogenation (HDN) rate, hydrodesulfurization (HDS) rate, hydrodeoxygenation (HDO) rate, hydrogenation rate, hydrodemetallation (HDM) rate, % carbon residue reduction (CRR), % microcarbon residue reduction (MCR), % residue conversion, increase in H/C ratio, reduction of molecular weights, changes in the percentages of Saturates, Aromatics, Resins, and Asphaltenes (SARA) fractions, increase in API such as increase in API gravity, reduction in density and the like. In one embodiment, a measurement can be in terms of hydrodenitrogenation (HDN) rate (h⁻¹), hydrodesulfurization (HDS) rate (h⁻¹), hydrodeoxygenation (HDO) (h⁻¹), hydrogenation rate (h⁻¹), hydrodemetallation (HDM) rate (h⁻¹) including the removal of nickel compounds (HDNi) and vanadium compounds (HDV), % carbon residue reduction (CRR), % microcarbon residue reduction (MCR), % residue conversion such as atmospheric (AR) or vacuum residue (VR) conversion, H/C ratio, molecular weight, changes in SARA (Saturates, Aromatics, Resins, and Asphaltenes) fractions, increase in API or reduction in density (gr/L) and the like. The one or more measurements of feedstock reactivity for the hydrocarbon-containing feedstock samples can readily be determined by methods known to one skilled in the art.

In another embodiment, the step of determining one or more solubility characteristics of the precipitated asphaltenes involves dissolving a first amount and a second amount of the precipitated asphaltenes by gradually and continuously changing the one or more first solvents to a final mobile phase solvent having a solubility parameter at least 1 MPa^{0.5} higher than the one or more first solvents. The first amount of the precipitated asphaltenes (also referred to as “easy to dissolve asphaltenes”) will have a lower solubility parameter than the second amount of asphaltenes (also referred to as “hard to dissolve asphaltenes”). The term gradually as used herein shall be understood to mean that the alkane mobile phase solvent is incrementally removed from the column over a period of time by continuously adding a final mobile phase solvent having a solubility parameter at least 1 MPa^{0.5} higher than the alkane mobile phase solvent to the column. Generally, gradually and continuously changing from essentially the alkane mobile phase solvent to the final mobile phase solvent can occur during a period of about 5 minutes to about 120 minutes at a flow rate of about 1 mL/min. to about 4 mL/min. In one embodiment, gradually and continuously changing from the alkane mobile phase solvent to the final mobile phase solvent can occur during a period of about 15 minutes to about 30 minutes at a flow rate of about 1 mL/min. to about 4 mL/min.

The first amount of the precipitated asphaltenes are dissolved by gradually and continuously changing the one or more first solvents to a first final mobile phase solvent having a solubility parameter at least 1 MPa^{0.5} higher than the alkane mobile phase solvent. As one skilled in the art will readily appreciate, the selection of the first final mobile phase solvent will depend on such factors as moving from a low solubility parameter solvent (low solvent power) to a high solubility parameter solvent (high solvent power) using solvents that have the right combination of dispersion, polar and hydrogen bonding forces. For example, a first final mobile phase solvent such as a chlorinated hydrocarbon solvent, e.g., dichloromethane, an ether solvent, an aromatic hydrocarbon solvent or mixtures thereof is gradually and continuously added to the column to sequentially change the one or more first solvents from 100% first solvent(s) to 100% first final mobile phase solvent, i.e., the first solvent(s) is changed to 1% dichloromethane in 99% first solvent(s), then to 2% dichloromethane in 98% first solvent(s), until the mobile phase solvent in the column is 100% dichloromethane and 0% first solvent(s). In this manner, a first amount of the precipitated asphaltenes (i.e., easy to dissolve asphaltenes) will be gradually dissolved and a characteristic elution pattern generated, which is referred to as the asphaltene solubility profile, as discussed herein below.

After the first amount of precipitated asphaltenes has been gradually dissolved, a second or remaining amount of the precipitated asphaltenes (which are not capable of being redissolved in the one or more first final mobile phase solvents) is left in the column. Thus, in order to redissolve the second amount of precipitated asphaltenes, also referred to as hard to dissolve asphaltenes (i.e., higher solubility parameter asphaltenes), it is may be necessary to add one or more second final mobile phase solvents having a solubility parameter at least 1 MPa^{0.5} higher than the first final mobile phase solvent to the column in order to substantially dissolve the remaining amount of the precipitated asphaltenes in the column and generate a characteristic elution pattern of the hydrocarbon-containing feedstock sample. This can advantageously allow for a more accurate determination of the solubility profile of the various asphaltene components in the hydrocarbon-containing feedstock sample.

The selection of the second final mobile phase solvent will depend on such factors as moving from a lower solubility parameter solvent (the first final mobile phase solvent) to a higher solubility parameter solvent (the second final mobile phase solvent) using solvents that have the right combination of dispersion, polar and hydrogen bonding forces. A suitable one or more second final mobile phase solvent can readily be determined by one skilled in the art, e.g., a C₁ to C₆ alcohol such as methanol. Accordingly, in one embodiment, methanol is gradually and continuously added to the column to sequentially change the first final mobile phase solvent, e.g., dichloromethane, from 100% dichloromethane to 100% methanol, i.e., dichloromethane is first changed to 1% methanol in 99% dichloromethane, then to 2% methanol in 98% dichloromethane, until the second final mobile phase solvent in the column is 100% methanol and 0% dichloromethane.

The flow rate and time period for gradually and continuously adding the one or more second final mobile phase solvents are substantially the same as for the first final mobile phase solvents.

The asphaltene concentration in the eluted fractions from the column is continuously monitored using, for example, a liquid chromatography detector as discussed hereinabove. In one preferred embodiment, an evaporative light scattering detector is used as a liquid chromatography detector to monitor each eluting sample's concentration to determine the solubility characteristics of the precipitated asphaltenes. For example, in the case of the asphaltenes, the result is a curve that represents the solubility parameter distribution of the asphaltenes.

Next, a solubility profile of the asphaltenes in the hydrocarbon-containing feedstock sample is created by techniques known in the art. For example, when asphaltenes are quantified using an evaporative light scattering detector, the result is a curve that represents the solubility parameter distribution of the asphaltene in the hydrocarbon-containing material. Since the solubility parameter of a mixture of solvents is given by the volumetric average of the components, it is possible to convert the time scale of the elution to a solubility parameter scale using the following equation:

$$δ = {\sum }_{i = 1}^{n} {φ}_{i} {δ}_{i}$$

wherein δ is the solubility profile of the mixture, φᵢ is the volume fraction and δᵢ is the solubility parameter of each of the components, respectively. The volume fraction is the volume fraction of the blend of each solvent and readily determined by the chromatography apparatus. The solubility parameter of a component is either known in the art, e.g., Barton, A. F. M. Handbook of Solubility Parameters and Other Cohesion Parameters; CRC Pres Inc.: Boca Raton, Fla., 1983, or can be determined by techniques within the purview of one skilled in the art.

Once a solubility profile of the asphaltenes in the hydrocarbon-containing feedstock sample has been created, one or more asphaltene stability parameters of the hydrocarbon-containing feedstock sample can then be determined. For example, one or more parameters can be mathematically calculated based on the solubility profile of the asphaltenes. An asphaltene solubility profile normally shows either two peaks or one peak and one shoulder from the evaporative light scattering detector. The two peaks or peak/shoulder can be separated by numerical methods well known in the art such as, for example, peak deconvolution or peak fitting. The first resolved peak is generally known as an “easy to dissolve asphaltene” peak and is derived from step (i) which gradually and continuously changes the one or more first solvents to a first final mobile phase solvent having a solubility parameter at least about 1 MPa^{0.5} higher than the one or more first solvents to dissolve a first amount of the precipitated asphaltenes. The second resolved peak or shoulder is generally known as a “hard to dissolve asphaltene” peak and is derived from step (ii) which gradually and continuously changes the first final mobile phase solvent to a second final mobile phase solvent having a solubility parameter at least about 1 MPa^{0.5} higher than the first final mobile phase solvent to dissolve a second, or remaining amount of precipitated asphaltenes. Examples of parameters related to asphaltene stability that can be calculated include the following.

1. Average solubility parameter of the hard to dissolve asphaltenes (SPA). This is a measurement of how difficult it is to dissolve the material eluted in the second peak or shoulder of the solubility profile (i.e., the hard to dissolve asphaltenes). It is calculated as the mean of the distribution corresponding to the second peak or shoulder obtained by the solubility parameter scale calculation discussed above. The higher the value, the more difficult it is to dissolve the hard to dissolve asphaltenes thereby indicating lower stability.

2. Ratio of hard-to-dissolve asphaltenes/easy to dissolve asphaltenes (i.e., second peak area/first peak area ratio wherein the second peak area and first peak area are derived from the solubility profile). After the separation of the peaks discussed hereinabove with respect to the asphaltene solubility profile, the areas for both peaks are calculated and the ratio between both areas determined. The area under the peaks can be determined using commercially available software packages for qualitative and quantitative analysis that include quantification of peak area and height. Commercially available software packages include, by way of example, GRAMS/AI package provided by Thermo Galactic (Salem, N.H.) and Chemstation® by Agilent Technologies (Santa Clara, Calif.). This ratio indicates whether there is enough transitional material or easy to dissolve asphaltenes (first peak) to keep the hard to dissolve (i.e., highly insoluble) asphaltenes (second peak) in solution. Accordingly, a smaller the ratio indicates a lower amount of transitional material or easy to dissolve asphaltenes present in the hydrocarbon-containing material in comparison with the more polar asphaltenes and hence a higher tendency of the latter to precipitate.

Overlapping of hard-to-dissolve asphaltenes to the easy to dissolve asphaltenes. This is a measurement of the compatibility between both species and, therefore, can be used to evaluate stability. After the separation of the peaks discussed hereinabove with respect to the asphaltene solubility profile, the area of both peaks are calculated as well as the overlapping area which corresponds with the area that both peaks share and lie in the same region. Accordingly, a higher value indicates greater stability and, therefore, the asphaltenes are less prone to precipitate.

ΔPS measures the broadness of the solubility profile and it is also related to the stability of the asphaltenes in the hydrocarbon-containing material. This parameter is calculated according to the following equation:

ΔPS=t(75%)−t(25%)

wherein t(75%) and t(25%) represent the time at which 75% and 25% of the asphaltenes in the hydrocarbon-containing material (in terms of area) have eluted, respectively. The ΔPS is calculated based on the cumulative areas of the whole distribution of times or solubility parameters that represent the solubility profile of the asphaltenes in the sample. Accordingly, a higher value indicates that a higher solubility parameter solvent is required to redisolved them and hence they present a lower stability and are more prone to precipitate.

Once one or more of the parameters related to asphaltene stability have been calculated for a given hydrocarbon-containing feedstock sample, the one or more parameters are correlated with one or more measurements of feedstock reactivity for the hydrocarbon-containing feedstock. The one or more measurements of feedstock reactivity for the hydrocarbon-containing feedstock sample can be any of those discussed above.

In one embodiment, after correlating the one or more measurements of feedstock reactivity for the hydrocarbon-containing feedstock sample with the one or more of the parameters related to asphaltene stability, one or more additional hydrocarbon-containing feedstock samples can be selected and subjected to substantially the same steps as the first hydrocarbon-containing feedstock sample. The results of these additional one or more hydrocarbon-containing feedstock samples can be compared with the results derived from the first hydrocarbon-containing feedstock sample to predict which of the samples are leading candidates for hydroprocessing reactivity.

In one embodiment, after correlating the one or more measurements of feedstock reactivity for the hydrocarbon-containing feedstock with the one or more of the parameters related to asphaltene stability, a different sample of the same hydrocarbon-containing feedstock can be characterized and then these results can be compared against the original hydrocarbon-containing feedstock for the purpose of, for example, quality control. A different sample can be from the same batch of the hydrocarbon-containing feedstock or can be from a different reservoir, field, country or continent. The various ways to compare the two hydrocarbon-containing feedstocks include comparing their API gravity, sulfur content, vanadium and nickel contents, distillable material contents, viscosity, asphaltene content, “easy-to-react” to “hard-to-process” asphaltenes, H/C ratio, molecular weight, SARA (Saturates, Aromatics, Resins, and Asphaltenes), Total Acid Number etc.

In another embodiment, the method of the present invention further includes the step of generating a cost value for the first hydrocarbon-containing feedstock sample or the leading candidates for hydroprocessing reactivity. The cost value can be generated based on factors such as API gravity, sulfur content, vanadium and nickel contents, distillable material contents, viscosity, asphaltene content, Total Acid Number, etc. The cost value generated for the first hydrocarbon-containing feedstock sample can then be compared with a market price of the same or different hydrocarbon-containing feedstock. In this manner, one can determine if the one or more hydrocarbon-containing feedstocks tested in the methods described herein are comparable to their market price.

The information obtained from the method of the present invention can then be stored in a relational database. For example, a relational database can be electrically connected to a signal data collector comprising a computer microprocessor for system operation and control to collect the data from the various tests over an extended period of time to compile a library therefrom. The database can be used to find optimum combinations for a desired product stream, and can be particularly useful when the desired product stream varies depending on market factors. When the product requirements change, appropriate combinations can be selected to prepare the desired product.

Once one or more of the hydrocarbon-containing feedstocks have been selected, one or more of the selected hydrocarbon-containing feedstocks can then be used as a refinery feedstock in one or more crude hydrocarbon refining components within a refinery and subjected to one or more conventional hydroprocessing techniques such as hydrotreating, hydrocracking, hydrogenation, hydrofinishing and hydroisomerization and the like. Alternatively, one or more of the selected hydrocarbon-containing feedstocks can be blended with one or more of the same or different hydrocarbon-containing feedstocks. The refinery hydroprocesses that the one or more of the selected hydrocarbon-containing feedstocks can be used in are well known in the art.

The term “crude hydrocarbon refinery component” generally refers to an apparatus or instrumentality of a process to refine crude hydrocarbons, such as an oil refinery process. Crude hydrocarbon refinery components include, but are not limited to, heat transfer components such as a heat exchanger, a furnace, a crude preheater, a coker preheater, or any other heaters, a FCC slurry bottom, a debutanizer exchanger/tower, other feed/effluent exchangers and furnace air preheaters in refinery facilities, flare compressor components in refinery facilities and steam cracker/reformer tubes in petrochemical facilities. Crude hydrocarbon refinery components can also include other instrumentalities in which heat transfer may take place, such as a fractionation or distillation column, a scrubber, a reactor, a liquid-jacketed tank, a pipestill, a coker and a visbreaker. It is understood that “crude hydrocarbon refinery components,” as used herein, encompass tubes, piping, baffles and other process transport mechanisms that are internal to, at least partially constitute, and/or are in direct fluid communication with, any one of the above-mentioned crude hydrocarbon refinery components.

In one embodiment, representative examples of such crude hydrocarbon refinery components include a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank, a visbreaker and the like.

Accordingly, another embodiment of the present invention is directed to a method involving:

(a) selecting one or more hydrocarbon-containing feedstocks, wherein the selection of the one or more hydrocarbon-containing feedstocks comprises:
(i) precipitating an amount of asphaltenes from a liquid sample of a first hydrocarbon-containing feedstock having solvated asphaltenes therein with one or more first solvents in a column;
(ii) determining solubility characteristics of the precipitated asphaltenes;
(iii) analyzing the solubility characteristics of the precipitated asphaltenes; and
(iv) correlating a measurement of feedstock reactivity for the first hydrocarbon-containing feedstock sample with a mathematical calculation derived from the results of analyzing the solubility characteristics of the precipitated asphaltenes; and

(b) feeding the selected one or more hydrocarbon-containing feedstocks to one or more crude hydrocarbon refinery components.

If desired, the selection of the one or more hydrocarbon-containing feedstocks can further employ one or more additional steps as discussed above, such as step (v) selecting one or more second hydrocarbon-containing feedstock samples; repeating steps (i)-(iv); and comparing the results of the one or more second hydrocarbon-containing feedstock samples with the results of the first hydrocarbon-containing feedstock sample to predict one or more leading candidate hydrocarbon-containing feedstocks for reactivity for hydroprocessing.

Another embodiment of the present invention is directed with a method of transforming a product development process to reduce time in bringing a product to market. In general the method involves the steps of: (a) precipitating an amount of asphaltenes from a liquid sample of a first hydrocarbon-containing feedstock having solvated asphaltenes therein with one or more first solvents in a column; (b) determining one or more solubility characteristics of the precipitated asphaltenes; (c) analyzing the one or more solubility characteristics of the precipitated asphaltenes; (d) correlating a measurement of feedstock reactivity for the first hydrocarbon-containing feedstock sample with a mathematical calculation derived from the results of analyzing the one or more solubility characteristics of the precipitated asphaltenes; and (e) generating a price of the first hydrocarbon-containing feedstock. The price of the first hydrocarbon-containing feedstock can readily be determined by one skilled in the art.

If desired, the method of transforming a product development process to reduce time in bringing a product to market can further include one or more additional steps as discussed above, such as the steps of (f) selecting one or more second hydrocarbon-containing feedstock samples; repeating steps (a)-(e); and comparing the results of the one or more second hydrocarbon-containing feedstock samples with the results of the first hydrocarbon-containing feedstock sample to predict which of the hydrocarbon-containing feedstock samples is a leading candidate for reactivity for hydroprocessing; and (g) selecting the leading candidate hydrocarbon-containing feedstocks based on reactivity of the hydrocarbon-containing feedstock for hydroprocessing and price.

The following non-limiting examples are illustrative of the present invention.

### Example 1

Solutions of seven reference heavy crude oil feedstocks shown in Table 1 were prepared by dissolving 0.1000 g of the feedstocks in 10 mL of methylene chloride. The solutions were injected into a separate stainless steel column packed with poly(tetrafluoroethylene) (PTFE) using a heptane mobile phase (Solubility Parameter of 15.3 MPa^{0.5}) at a flow rate of 4 mL/min. The maltenes (heptane solubles) eluted from the column as the first peak around 2 minutes after the injection. The mobile phase was then switched in successive steps to solvents of increasing solubility parameters: (1) 10 minutes after the addition of the heptane phase, a blend of 15% dichloromethane/85% n-heptane (Solubility Parameter of 16.05 MPa^{0.5}) was added to the column; (2) 20 minutes after the addition of the blend of 15% dichloromethane/85% n-heptane, a blend of 30% dichloromethane/70% n-heptane (Solubility Parameter of 18.8 MPa^{0.5}) was added to the column; (3) 30 minutes after the addition of the blend of 30% dichloromethane/70% n-heptane, 100% dichloromethane (Solubility Parameter of 20.3 MPa^{0.5}) was added to the column; and (4) 40 minutes after the addition of 100% dichloromethane, a blend of 10% methanol/90% dichloromethane (Solubility Parameter of 21.23 MPa0.5) was added to the column. In this manner, four different asphaltenes solubility fractions were separated with a total analysis time of approximately 50 to 55 minutes.

TABLE 1¹

| | | % Asphaltenes | Micro Carbon | H/C |
|---|---|---|---|---|
| | API (60/60) | (C7)² | Residue (wt %) | molar |
| Canadian VR | 3.9 | 10.0 | 17.2 | 1.44 |
| Middle East VR | 4.8 | 10.7 | 22.2 | 1.46 |
| Venezuelan VR-1 | 2.7 | 22.1 | 24.5 | 1.42 |
| Venezuelan VR-2 | 1.3 | 23.6 | 88.0 | 1.37 |
| Mexican VR | 1.0 | 22.4 | 93.5 | 1.35 |
| California VR | 5.1 | 14.6 | 86.0 | 1.43 |
| California Solvent | 1.8 | 29.5 | 31.3 | 1.25 |
| De-Asphalted | | | | |

¹VR = 1000⁺° F. vacuum residue
²Determined by correlation of the total area under peaks and the gravimetric content as determined by the test method according to ASTM D-6560 (2005)

The eluted fractions were quantified using an Evaporative Light Scanning Detector (ELSD) operating at the following conditions: drift tube temperature 75° C.; volumetric flow of the solvents was 4.0 mL/min. and 3.5 L/min. of nitrogen as the nebulizing gas. The light scattered by the non-volatile particles was collected and is a measure of the concentration of the solute in the column effluent. For the case of asphaltenes, the measurement of the light scattered, also known as response, represents the solubility characteristics of the asphaltenes present in the sample.

The eluted fractions were also quantified using a Diode Array Detector (DAD) operating at 495 nm. In this case, the absorbance of each asphaltene fraction is directly proportional to its concentration present in the sample.

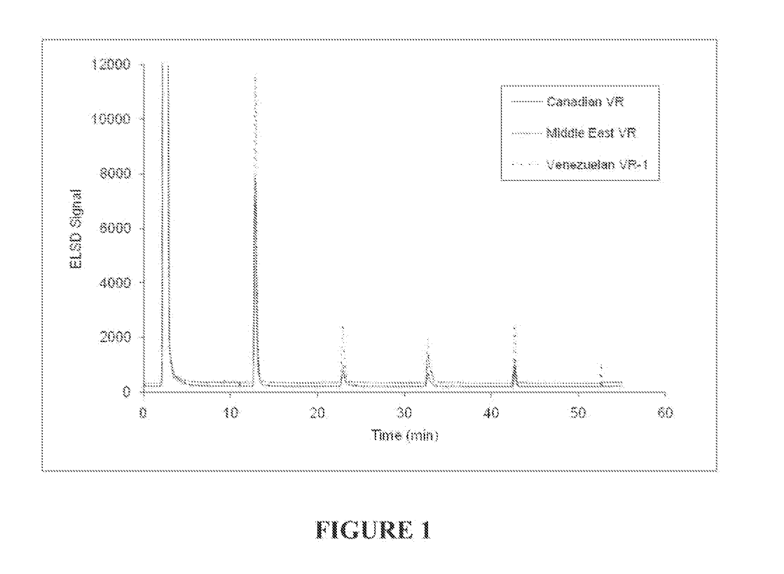

FIG. 1 shows the resulting solubility characteristics of the asphaltene solubility fraction distributions for three of the reference feedstocks set forth in Table 1 as response versus time using the ELSD. This figure indicates the presence of four distinct features represented by separated peaks. In FIG. 1, the first peak corresponds to the eluted maltenes (heptane solubles) and the last four peaks correspond to each of the eluted asphaltenes from the four different solvent additions. From left to right, the asphaltenes are separated in increasing solubility parameters, i.e., the first peak is considered the “easy-to-react” asphaltenes and the last peak is considered the “hard-to-process” asphaltenes. The ELSD allows for calculating a percentage of peak area for each of the dissolved asphaltenes.

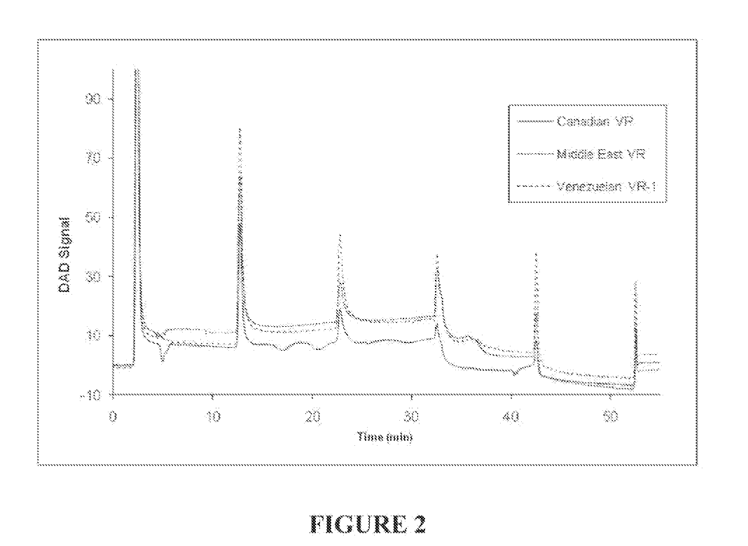

FIG. 2 shows the resulting solubility characteristics of the asphaltene solubility fraction distributions for three of the reference feedstocks set forth in Table 1 as response versus time using the DAD. As stated above, the first peak corresponds to the maltenes (heptane solubles) and the last four peaks correspond to each of the eluted asphaltenes from the four different solvent additions in increasing solubility parameters. The DAD also allows calculating a percentage of peak area for each of the dissolved asphaltenes.

FIGS. 1 and 2 confirm that asphaltenes from each of the different reference feedstocks exhibit different solubility characteristics and that these differences can be measured using the procedure mentioned above.

### Example 2

Determining feedstock reactivity in terms of hydrodenitrogenation (HDN) rate (h⁻¹).

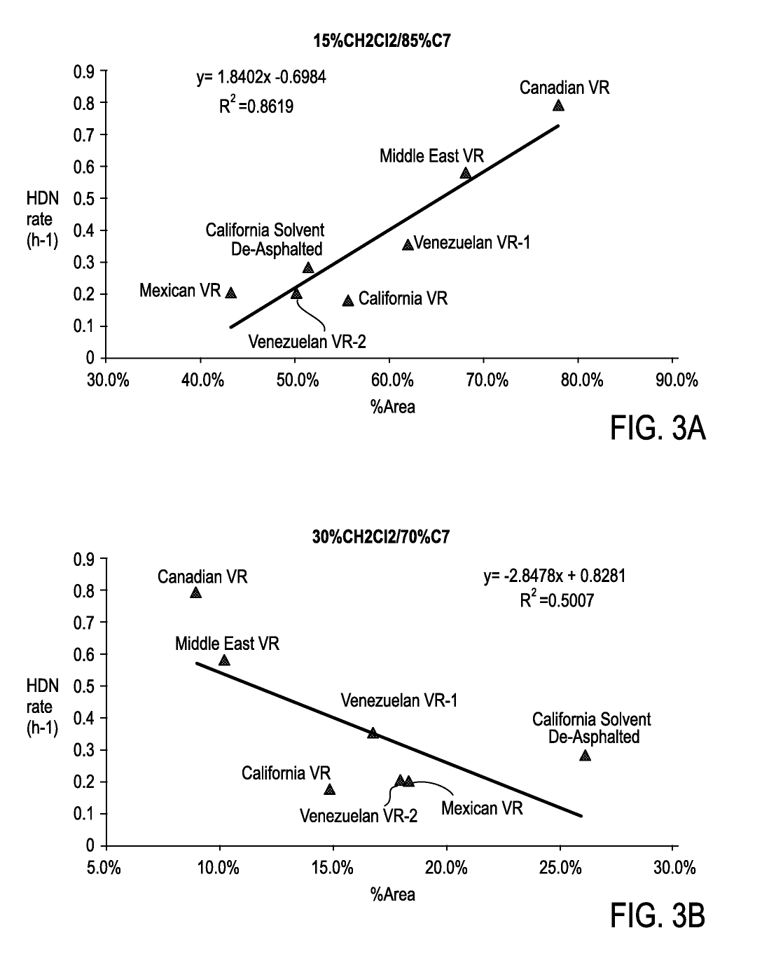

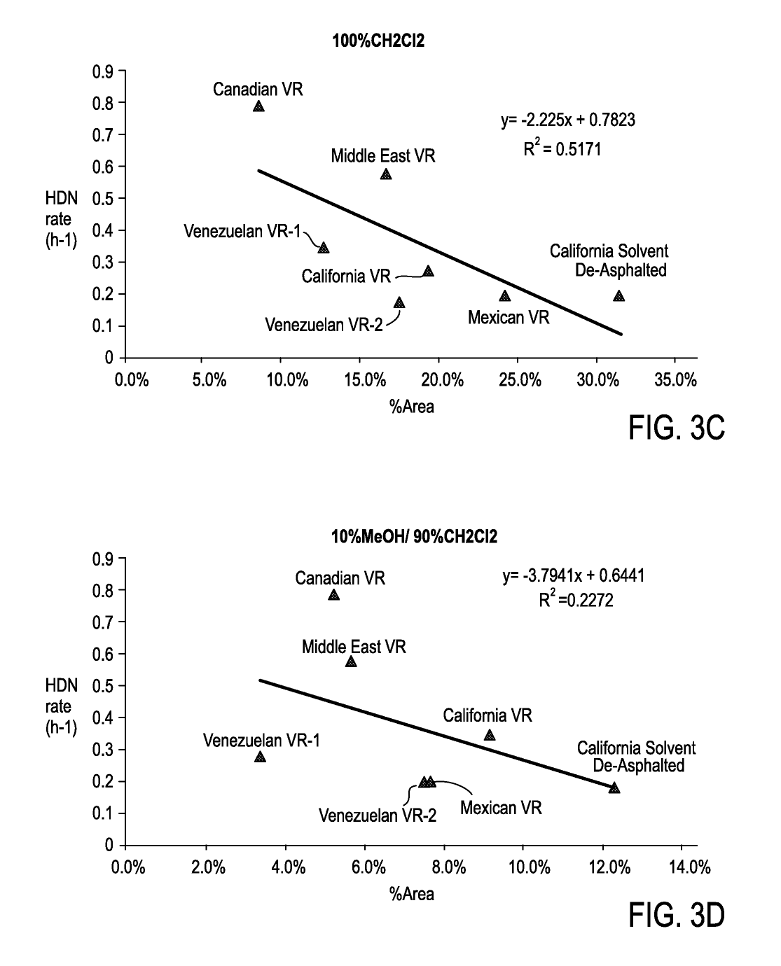

In FIG. 3, the percentages of areas of each solubility fraction from FIG. 1 are plotted versus the feedstock reactivity to hydroprocessing measured in terms of HDN rate (h⁻¹) for each of the reference feedstocks. As shown in FIG. 3, the rate of HDN increases with the amount of 15% CH₂Cl₂/85% C₇ soluble asphaltenes in the feeds and is inversely proportional to the content of the other three fractions (30% CH₂Cl₂/70% C₇, 100% CH₂Cl₂ and 10% MeOH/90 CH₂Cl₂). However, the correlation coefficients for all the plots were quite poor varying in the 0.2 to 0.6 range.

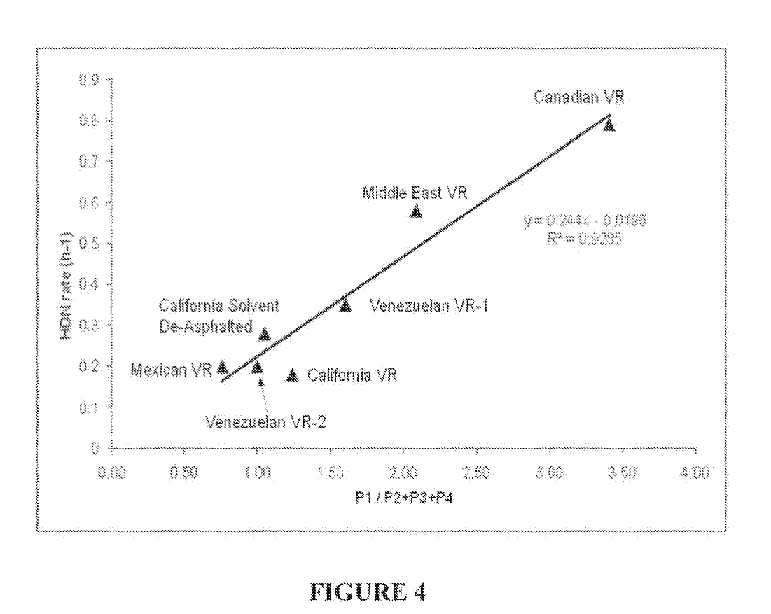

FIG. 4 shows the feedstocks reactivity to hydroprocessing of the reference feedstocks in terms of HDN rate plotted versus the ratio of areas of “easy-to-react” to “hard-to-process” asphaltenes. As can be seen, for each of the reference feedstocks samples, there is an improved correlation (R²=0.9285) between the HDN rate and the ratio “easy-to-react” to “hard-to-process” asphaltenes.

In order to improve even further the correlation between reference feedstock reactivity and the asphaltene solubility fraction, a new Feed Reactivity 1 parameter (eq. 1) was introduced by using the percentage of asphaltene content (Table 1) and a linear combination of all the areas of the asphaltene solubility fractions.

Feed Reactivity 1=(% Asphalt.)^{A}[B% Area(15% CH₂Cl₂/85% C7)+C% Area(30% CH₂Cl₂/70% C7)+D % Area(100% CH₂Cl₂)+E % Area(10% MeOH/90% CH₂Cl₂)] (1)

wherein A=−0.3322; B=2.6322; C=−1.076; D=−0.0249; E=−6.705

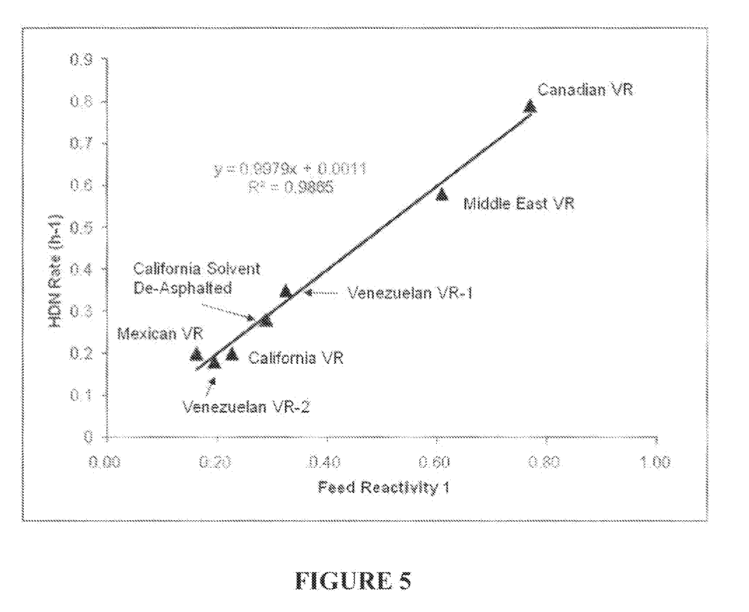

The correlation parameters for Feed Reactivity 1 were obtained by linear combination of the percent of areas of asphaltene solubility fractions using the software SigmaPlot (available from Systact Software Inc.). As shown in FIG. 5, Feed Reactivity 1 is plotted vs. HDN rate and an improved correlation was obtained with a R² higher (0.9865) than the correlation (R²=0.9285) shown in FIG. 4.

Thus, by using either the ratio of areas of “easy-to-react” to “hard-to-process” asphaltenes or Feed Reactivity 1, the reactivity to hydroprocessing of an unknown hydrocarbon-containing feedstock can be predicted in terms of HDN rate (h⁻¹).

### Example 3

Determining feedstock reactivity in terms of reduction of microcarbon residue (MCR).

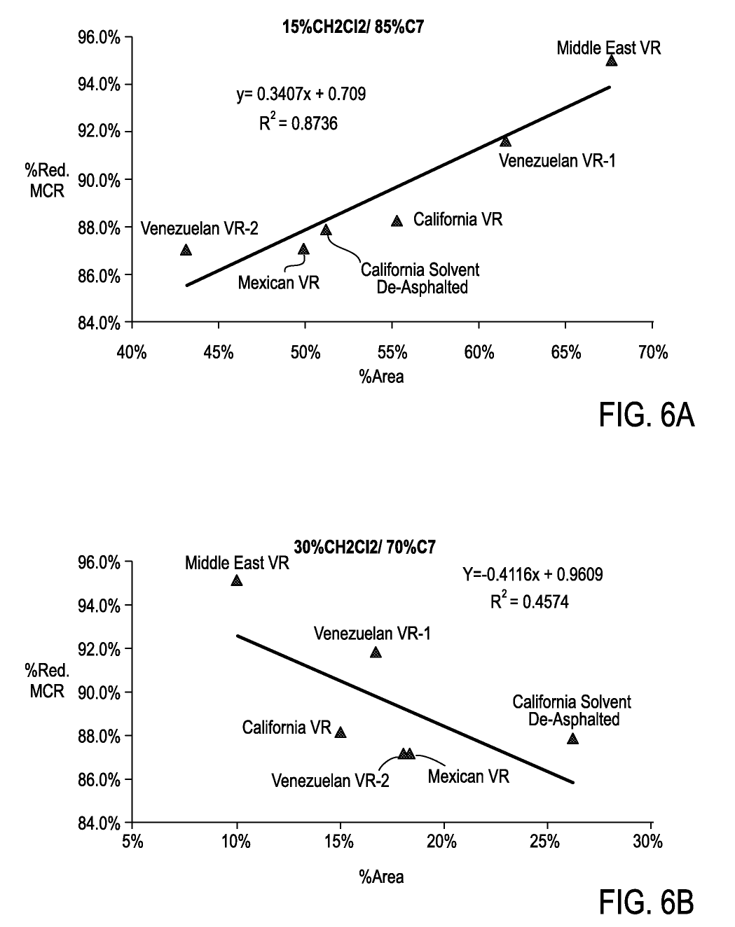

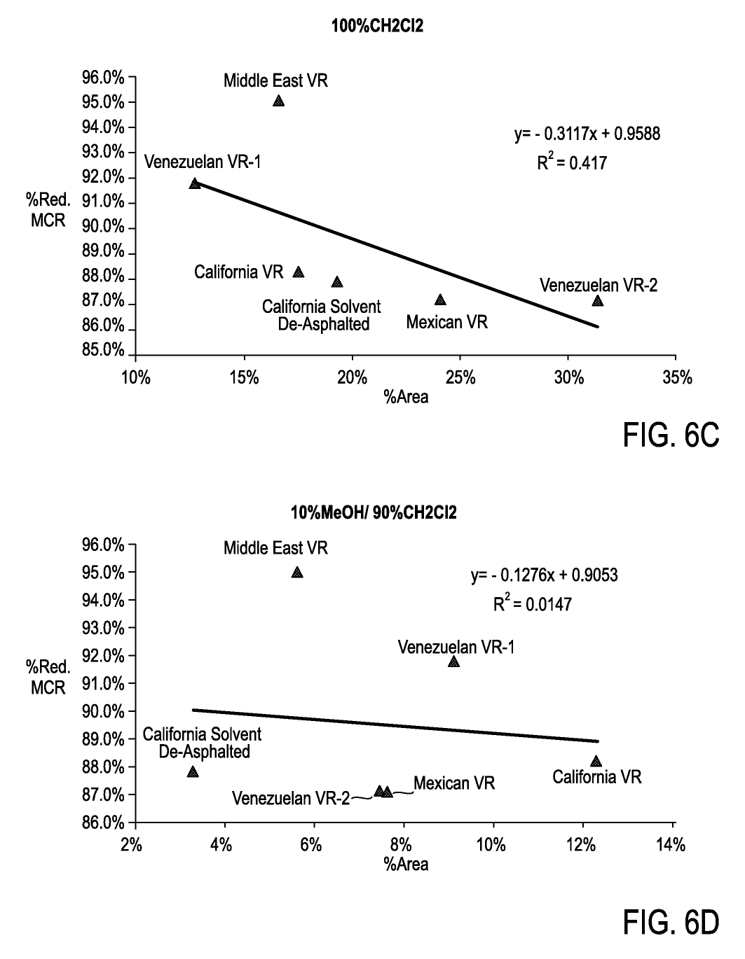

In FIG. 6, the percentages of areas of each solubility fraction from Table 1 were plotted versus the feedstock reactivity to hydroprocessing measured in terms of % of reduction of MCR for all reference feedstocks. As can be seen, the reduction of MCR increases with the amount of 15% CH₂Cl₂/85% C₇ soluble asphaltenes in the feeds and is inversely proportional to the content of the other three fractions (30% CH₂Cl₂/70% C₇, 100% CH₂Cl₂ and 10% MeOH/90 CH₂Cl₂). However, the correlation coefficients for all the plots are quite poor varying in the 0.01 to 0.8 range.

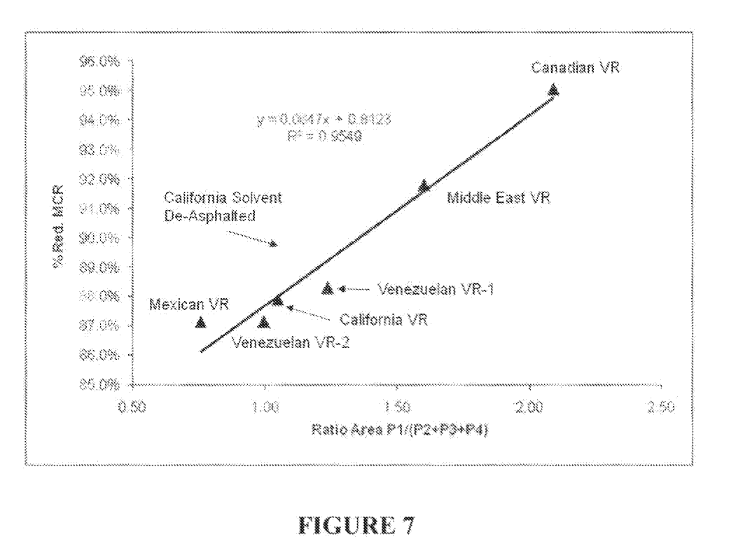

FIG. 7 shows the percentage of reduction of MCR plotted versus the ratio of areas of “easy-to-react” to “hard-to-process” asphaltenes. As can be seen, for the reference feedstocks samples, there is an improved correlation (R²=0.9285) between the reactivity to hydroprocessing and the ratio “easy-to-react” to “hard-to-process” asphaltenes.

Thus, by using the ratio of areas of “easy-to-react” to “hard-to-process” asphaltenes, the reactivity to hydroprocessing of an unknown hydrocarbon-containing feedstock can be predicted in terms of percentage of reduction of MCR.

### Example 4

Solutions of seven reference feedstocks shown in Table 2 were prepared by dissolving 0.1000 g of the heavy crude oil in 10 mL of methylene chloride. The solutions were injected into a separate stainless steel column packed with PTFE using a heptane mobile phase at a flow rate of 4 mL/min. The maltenes (heptane solubles) eluted from the column as the first peak around 2 minutes after the injection. After 10 minutes, a first final mobile phase solvent of 90/10 methylene chloride/methanol blend was passed into the column at a flow rate of 4 mL/min. The change of the solvent from heptane to the methylene chloride/methanol blend redissolved a portion of the asphaltenes which started to elute around 12 minutes. After 20 minutes, a second final mobile phase of 100% methanol was passed into the column at a flow rate of 4 mL/min. to redissolve the remaining portion of the asphaltenes.

TABLE 2¹

| | | % Asphaltenes | Micro Carbon | H/C |
|---|---|---|---|---|
| | API (60/60) | (C₇)² | Residue (wt %) | molar |
| Canadian VR | 3.9 | 10.0 | 17.2 | 1.44 |
| Middle East VR | 4.8 | 10.7 | 22.2 | 1.46 |
| Venezuelan VR-1 | 2.7 | 22.1 | 24.5 | 1.42 |
| Venezuelan VR-2 | 1.3 | 23.6 | 88.0 | 1.37 |
| Mexican VR | 1.0 | 22.4 | 93.5 | 1.35 |
| California VR | 5.1 | 14.6 | 86.0 | 1.43 |
| California Solvent | 1.8 | 29.5 | 31.3 | 1.25 |
| De-Asphalted | | | | |

¹VR = 1000⁺° F. vacuum residue
²Determined by correlation of the total area under peaks and the gravimetric content as determined by the test method according to ASTM D-6560 (2005)

The concentration of maltenes and asphaltenes were quantified using an ELSD (Alltech ELSD 2000) which was equipped with a light-scattering detector by evaporating the solvent and passing the stream containing non-volatile particles (asphaltenes or maltenes) through the light-scattering photometer. The ELSD conditions were the following: drift tube temperature 75° C.; volumetric flow of the solvents was 4.0 mL/min. and 3.5 L/min. of nitrogen as the nebulizing gas. The light scattered by the non-volatile particles was collected and is a measure of the concentration of the solute in the column effluent. For the case of asphaltenes, the measurement of the light scattered, also known as response, represents the solubility characteristics of the asphaltenes present in the sample. The time scale can be converted to a solubility parameter scale using the regular solutions approach (See: Barton, A. F. M., Handbook of Solubility Parameters and other Cohesion Parameters, CRC Press, USA, 1991, p. 63). The curves represent the distribution of solubility parameters in the asphaltenes or solubility profile.

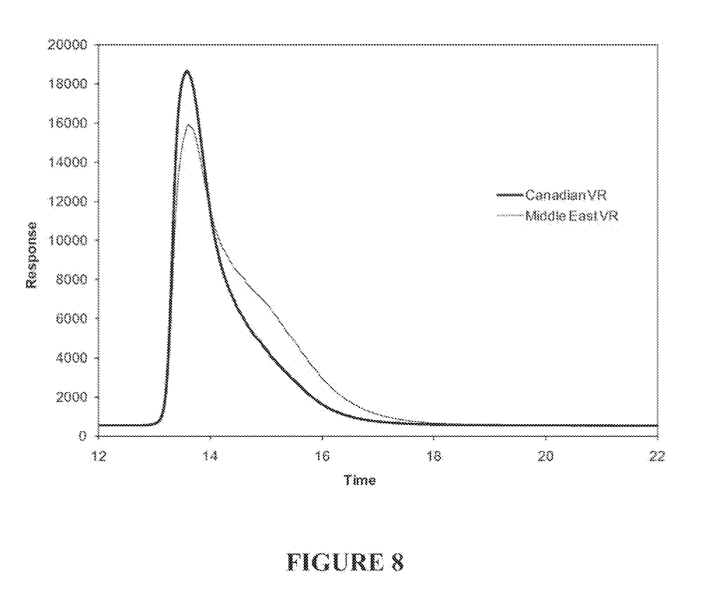

FIG. 8 shows the resulting asphaltene solubility profiles for both Samples #1 and #2 as response versus time for the asphaltenes. This figure indicates the presence of two distinct features in each curve represented by separated peaks or a peak and a shoulder. In FIG. 8, the first peak for both curves corresponds to “easy to dissolve asphaltenes” and the second peak (or second shoulder) corresponds to “hard to dissolve asphaltenes”. The data in FIG. 8 confirms that asphaltenes from different crude oils exhibit different solubility characteristics and that these differences can be measured using the procedure mentioned above

### Example 5

Determining feedstock reactivity in terms of HDN rate (h⁻¹).

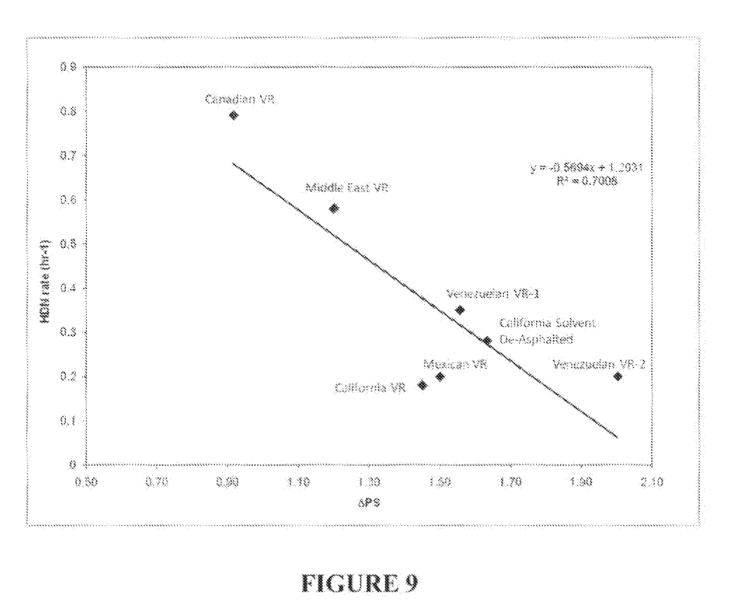

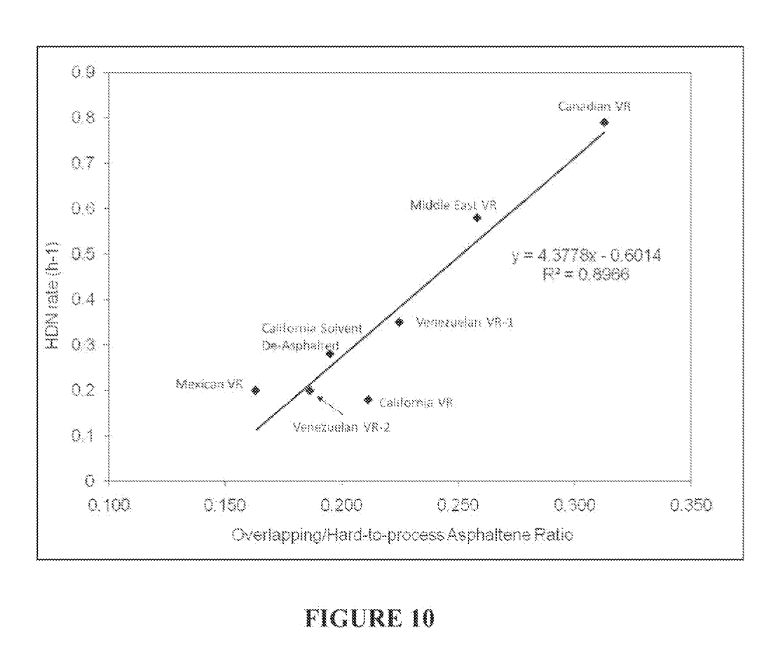

Asphaltene stability or the asphaltene peptization state can affect the reactivity of a feed to be hydroprocessed. In FIGS. 9 and 10, the feedstock reactivity measured in terms of HDN rate (h⁻¹) for the seven reference feedstocks was plotted as a function of two parameters: ΔPS and overlapping area (between the hard-to-dissolve asphaltene and easy to dissolve asphaltenes)/hard-to-dissolve asphaltene ratio. As can be seen, ΔPS (R²=0.70) and overlapping area of hard to dissolve asphaltenes to easy to dissolve asphaltenes (R²=0.90), which are closely related to stability, correlate reasonable well with reactivity of the reference feedstocks to be hydroprocessed.

To further correlate between reference feedstock reactivity and the asphaltene solubility profile, a Feed Reactivity 2 parameter (eq. 2) was introduced by using the percentage of overlapping/hard-to-dissolve asphaltene ratio and hard-to-dissolve asphaltenes/easy to dissolve asphaltenes ratio:

Feed Reactivity 2=A+B*Overlapping/hard-to-process asphaltenes ratio+C*hard-to-dissolve asphaltenes/easy to dissolve asphaltenes ratio (2)

where A=−1.463, B=6.801 and C=0.125

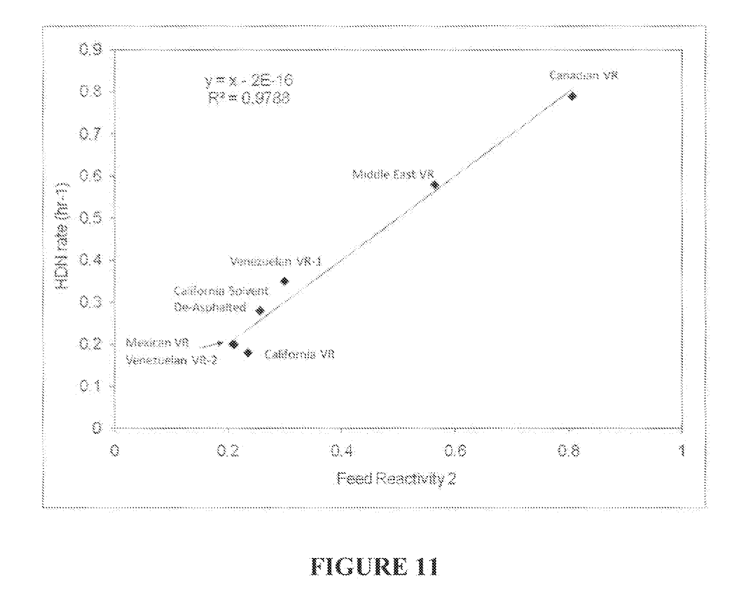

In equation 2, the coefficients were calculated by multiple linear regression using Excel from Microsoft Corp. As can be seen in FIG. 11, Feed Reactivity 2 was plotted vs. HDN rate and an improved correlation was obtained with a R² higher (0.9788) than the previous cases (0.70 to 0.90).

Thus, by using either the APS, ratio of areas of overlapping/hard-to-dissolve asphaltene or the Feed Reactivity 2 parameter, the reactivity to hydroprocessing of an unknown hydrocarbon-containing feedstock can be predicted in terms of HDN rate (h⁻¹).

### Example 6

Determining feedstock reactivity in terms of reduction of microcarbon residue (MCR).

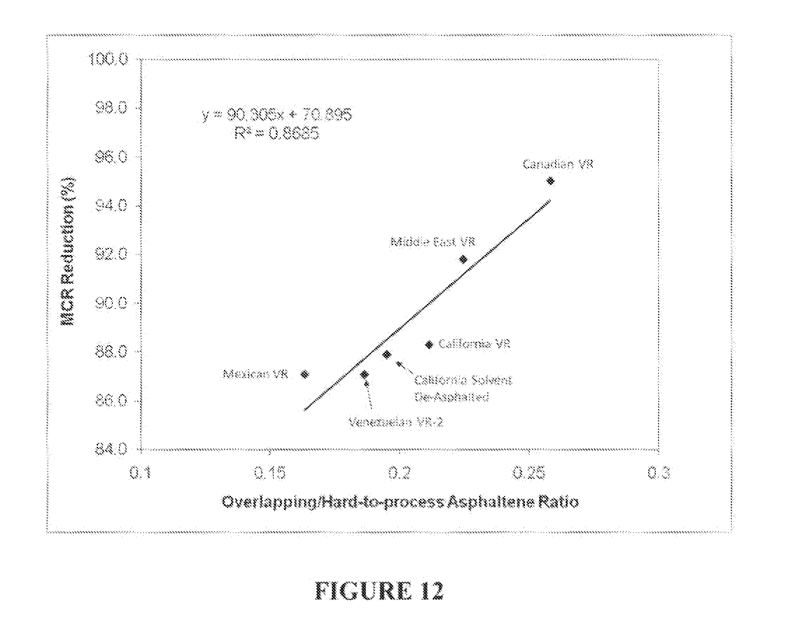

FIG. 12 shows the ratio of areas overlapping area/hard-to-dissolve asphaltene plotted versus the feedstock reactivity to hydroprocessing measured in terms of % of reduction of MCR. As can be seen, there is a correlation (R²=0.8685) between the reactivity to hydroprocessing and the overlapping/hard-to-dissolve asphaltene ratio for the reference feedstock samples.

To further correlate between reference feedstock reactivity and the asphaltene solubility profile, a Feed Reactivity 3 parameter (eq. 3) was introduced by using the percentage of overlapping/hard-to-dissolve asphaltene ratio and hard-to-dissolve asphaltenes/easy to dissolve asphaltenes ratio:

Feed Reactivity 3=A+B*Overlapping/hard-to-dissolve asphaltenes ratio+C*hard-to-dissolve asphaltenes/easy to dissolve asphaltenes ratio (3)

wherein A=58.444, B=129.496 and C=1.530

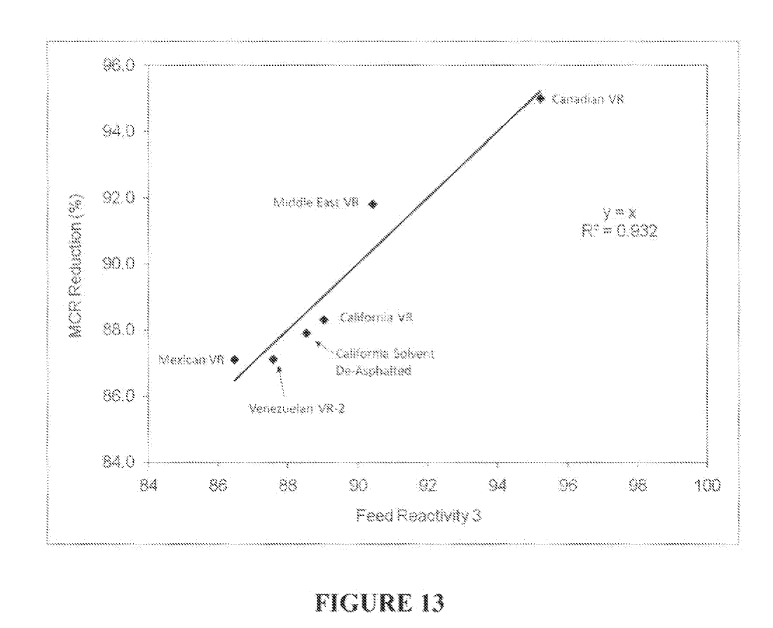

In equation 3, the coefficients were calculated by multiple linear regression using Excel from Microsoft Corp. As can be observed in FIG. 13, Feed Reactivity 3 is plotted vs. percentage of MCR reduction and an improved correlation was obtained with a R² higher (0.932) than the previous case (0.8685).

Thus, by using either the ratio of areas of overlapping/hard-to-dissolve asphaltene or the Feed Reactivity 3 parameter, the reactivity to hydroprocessing of an unknown hydrocarbon-containing feedstock can be predicted in terms of percentage of MCR reduction.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method comprising the steps of:
(a) precipitating an amount of asphaltenes from a liquid sample of a first hydrocarbon-containing feedstock having solvated asphaltenes therein with one or more first solvents in a column;
(b) determining one or more solubility characteristics of the precipitated asphaltenes;
(c) analyzing the one or more solubility characteristics of the precipitated asphaltenes; and
(d) correlating a measurement of feedstock reactivity for the first hydrocarbon-containing feedstock sample with a mathematical parameter derived from the results of analyzing the one or more solubility characteristics of the precipitated asphaltenes.

2. The method of claim 1, wherein the first hydrocarbon-containing feedstock comprises coal tars, shale oils, shale, tar sand bitumen, asphalts, light crude oil, and heavy crude oil or fractions thereof.

3. The method of claim 1, wherein the one or more first solvents is selected from the group consisting of iso-octane, pentane, hexane, heptane and mixtures thereof.

4. The method of claim 1, wherein step (b) comprises
(i) dissolving at least part of the amount of the precipitated asphaltenes in one or more second solvents having a solubility parameter at least about 0.7 MPa^{0.5} higher than the one or more first solvents;
(ii) dissolving a second amount of the precipitated asphaltenes in one or more third solvents having a solubility parameter higher than the one or more second solvents, wherein the solubility parameter of the one or more third solvents is at least about 21 MPa^{0.5} but no greater than about 30 MPa^{0.5}.

5. The method of claim 4, wherein step (c) comprises monitoring the amount of eluted fractions from the column with a liquid chromatography detector which generates a signal proportional to the amount of each eluted fraction.

6. The method of claim 5, comprising calculating a percentage of each peak area for the first amount and the second amount of dissolved asphaltenes from the total peak areas, wherein the peak areas are derived from the signals.

7. The method of claim 4, further comprising prior to step (ii):
dissolving at least part of the amount of the precipitated asphaltenes in one or more fourth solvents having a solubility parameter between the solubility parameter of the second solvent and the solubility parameter of the third solvent;
dissolving at least part of the amount of the precipitated asphaltenes in one or more fifth solvents having a solubility parameter between the solubility parameter of the fourth solvent and the solubility parameter of the third solvent.

8. The method of claim 7, wherein step (c) comprises monitoring the concentration of eluted fractions from the column with a liquid chromatography detector which generates a signal proportional to the amount of each eluted fraction.

9. The method of claim 8, comprising calculating a percentage of each peak area for the first amount and the second amount of dissolved asphaltenes from the total peak areas, wherein the peak areas are derived from the signals.

10. The method of claim 1, wherein step (b) comprises dissolving a first amount and a second amount of the precipitated asphaltenes by gradually and continuously changing the one or more first solvents to a final mobile phase solvent having a solubility parameter at least about 1 MPa^{0.5} higher than the one or more first solvents.

11. The method of claim 1, wherein step (b) comprises:
(i) gradually and continuously changing the one or more first solvents to a first final mobile phase solvent having a solubility parameter at least about 1 MPa^{0.5} higher than the one or more first solvents to dissolve a first amount of the precipitated asphaltenes; and
(ii) gradually and continuously changing the first final mobile phase solvent to a second final mobile phase solvent having a solubility parameter at least about 1 MPa^{0.5} higher than the first final mobile phase solvent to dissolve a second amount of the precipitated asphaltenes.

12. The method of claim 11, wherein step (c) comprises monitoring the concentration of eluted fractions from the column with a liquid chromatography detector.

13. The method of claim 11, comprising
creating a solubility profile of the dissolved asphaltenes in the first hydrocarbon-containing feedstock sample; and
determining one or more asphaltene stability parameters of the first hydrocarbon-containing feedstock sample.

14. The method of claim 13, wherein the step of determining one or more asphaltene stability parameters comprises calculating an average solubility parameter of the second amount of dissolved asphaltenes.

15. The method of claim 14, wherein the average solubility parameter of the second amount of dissolved asphaltenes is calculated as a mean of a distribution corresponding to a peak or shoulder of the second amount of dissolved asphaltenes derived from the solubility profile.

16. The method of claim 13, wherein the step of determining one or more asphaltene stability parameters comprises calculating a ratio of peak areas of the second amount of dissolved asphaltenes to the first amount of dissolved asphaltenes, wherein each of the peak areas are derived from the solubility profile.

17. The method of claim 13, wherein the step of determining one or more asphaltene stability parameters comprises calculating the overlapping area of the peak areas of the second amount of dissolved asphaltenes and the first amount of dissolved asphaltenes.

18. The method of claim 13, wherein the step of determining one or more asphaltene stability parameters comprises calculating an overlapping area of peak areas of the second amount of dissolved asphaltenes and the first amount of dissolved asphaltenes, wherein each of the peak areas are derived from the solubility profile.

19. The method of claim 13, wherein the step of determining one or more asphaltene stability parameters comprises calculating ΔPS from an equation:
ΔPS=t(75%)−t(25%)
wherein t(75%) and t(25%) represent the time at which 75% and 25% of the asphaltene in the hydrocarbon-containing material have eluted.

20. The method of claim 1, wherein the measurement of feedstock reactivity comprises one or more measurements in terms of hydrodenitrogenation (HDN) rate, hydrodesulfurization (HDS) rate, hydrodeoxygenation (HDO) rate, hydrogenation rate, hydrodemetallation (HDM) rate, % carbon residue reduction (CRR), % microcarbon residue reduction (MCR), % residue conversion, increase in H/C ratio, reduction of molecular weights, changes in the percentages of Saturates, Aromatics, Resins, and Asphaltenes (SARA) fractions, increase in API or reduction in density.

21. The method of claim 1, wherein the mathematical parameter is further derived from the total asphaltene content in the first hydrocarbon-containing feedstock sample.

22. The method of claim 1, further comprising the steps of
(e) selecting one or more of the same or different hydrocarbon-containing feedstock samples; repeating steps (a)-(d); and
(f) comparing the results of the one or more of the same or different hydrocarbon-containing feedstock samples with the results of the first hydrocarbon-containing feedstock sample to predict one or more leading candidate hydrocarbon-containing feedstocks for reactivity for hydroprocessing.

23. The method of claim 22, further comprising the step of blending the leading candidate hydrocarbon-containing feedstock with one or more different hydrocarbon-containing feedstocks.

24. The method of claim 1, further comprising the step of comparing a different sample of the same first hydrocarbon-containing feedstock sample with the first hydrocarbon-containing feedstock sample for quality control of the first hydrocarbon-containing feedstock sample.

25. The method of claim 1, further comprising the step of storing the results of correlating of step (d) in a database.

26. The method of claim 1, further comprising the step of generating a cost value for the first hydrocarbon-containing feedstock sample.

27. The method of claim 26, further comprising the step of comparing the cost value generated for the first hydrocarbon-containing feedstock sample with a market price of the same or different hydrocarbon-containing feedstock.

28. The method of claim 22, further comprising the step of generating a cost value for the leading candidate hydrocarbon-containing feedstock samples.

29. The method of claim 28, further comprising the step of comparing the cost value generated for the leading candidate hydrocarbon-containing feedstock samples with a market price of the same or different hydrocarbon-containing feedstocks.

30. A method comprising the steps of:
(a) selecting one or more hydrocarbon-containing feedstocks, wherein the selection of the one or more hydrocarbon-containing feedstocks comprises:
(i) precipitating an amount of asphaltenes from a liquid sample of a first hydrocarbon-containing feedstock having solvated asphaltenes therein with one or more first solvents in a column;
(ii) determining one or more solubility characteristics of the precipitated asphaltenes;
(iii) analyzing the one or more solubility characteristics of the precipitated asphaltenes; and
(iv) correlating a measurement of feedstock reactivity for the first hydrocarbon-containing feedstock sample with a mathematical calculation derived from the results of analyzing the one or more solubility characteristics of the precipitated asphaltenes; and
(b) feeding the selected hydrocarbon-containing feedstock to one or more crude hydrocarbon refinery components.

31. The method of claim 30, further comprising
(v) selecting one or more second hydrocarbon-containing feedstock samples; repeating steps (i)-(iv); and comparing the results of the one or more second hydrocarbon-containing feedstock samples with the results of the first hydrocarbon-containing feedstock sample to predict one or more leading candidate hydrocarbon-containing feedstocks for reactivity for hydroprocessing

32. The method of claim 30, wherein the one or more crude hydrocarbon refinery components are selected from the group consisting of a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank and a visbreaker.

33. A system comprising: (a) one or more crude oil hydrocarbon components; and (b) one or more hydrocarbon-containing feedstocks in fluid communication with the one or more crude hydrocarbon refinery components, wherein the one or more hydrocarbon-containing feedstocks are selected by a process comprising:
(i) precipitating an amount of asphaltenes from a liquid sample of a first hydrocarbon-containing feedstock having solvated asphaltenes therein with one or more first solvents in a column;
(ii) determining one or more solubility characteristics of the precipitated asphaltenes;
(iii) analyzing the one or more solubility characteristics of the precipitated asphaltenes; and
(iv) correlating a measurement of feedstock reactivity for the first hydrocarbon-containing feedstock sample with a mathematical calculation derived from the results of analyzing the one or more solubility characteristics of the precipitated asphaltenes.

34. The system of claim 33, wherein the process further comprises:
(v) selecting one or more second hydrocarbon-containing feedstock samples; repeating steps (i)-(iv); and comparing the results of the one or more second hydrocarbon-containing feedstock samples with the results of the first hydrocarbon-containing feedstock sample to predict one or more leading candidate hydrocarbon-containing feedstocks for reactivity for hydroprocessing

35. The system of claim 33, wherein the one or more crude hydrocarbon refinery components are selected from the group consisting of a heat exchanger, a furnace, a crude preheater, a coker preheater, a FCC slurry bottom, a debutanizer exchanger, a debutanizer tower, a feed/effluent exchanger, a furnace air preheater, a flare compressor component, a steam cracker, a steam reformer, a distillation column, a fractionation column, a scrubber, a reactor, a liquid-jacketed tank, a pipestill, a coker, a storage tank and a visbreaker

36. A method of transforming a product development process to reduce time in bringing a product to market, the method comprising the steps of:
(a) precipitating an amount of asphaltenes from a liquid sample of a first hydrocarbon-containing feedstock having solvated asphaltenes therein with one or more first solvents in a column;
(b) determining one or more solubility characteristics of the precipitated asphaltenes;
(c) analyzing the one or more solubility characteristics of the precipitated asphaltenes;
(d) correlating a measurement of feedstock reactivity for the first hydrocarbon-containing feedstock sample with a mathematical calculation derived from the results of analyzing the solubility characteristics of the precipitated asphaltenes; and
(e) generating a price of the first hydrocarbon-containing feedstock.

37. The method of claim 36, further comprising the steps of:
(f) selecting one or more second hydrocarbon-containing feedstock samples; repeating steps
(a)-(e); and comparing the results of the one or more second hydrocarbon-containing feedstock samples with the results of the first hydrocarbon-containing feedstock sample to predict which of the hydrocarbon-containing feedstock samples is a leading candidate for reactivity for hydroprocessing; and
(g) selecting the leading candidate hydrocarbon-containing feedstocks based on reactivity of the hydrocarbon-containing feedstock for hydroprocessing and price.
